(19) United States
(12) Patent Application Publication
(10) Pub. No.: US 2026/0275871 A1
(43) Pub. Date: Sep. 17, 2026

(54) EXPANDER AND THERMODYNAMIC CYCLE USING THE EXPANDER

(71) Applicant: NUOVO PIGNONE TECNOLOGIE - S.R.L., Florence (IT)

(72) Inventors: Gabriele GIREZZI, Florence, Firenze (IT); Giacomo RAGNI, Florence, Firenze (IT); Paolo DI SISTO, Florence, Firenze (IT); Damaso CHECCACCI, Florence, Firenze (IT); Lorenzo COSI, Florence, Firenze (IT); Enrico GIUSTI, Florence, Firenze (IT); Fabio VALERI, Florence, Firenze (IT)

(21) Appl. No.: 19/469,187

(22) PCT Filed: Mar. 25, 2024
(86) PCT No.: PCT/EP2024/025127

§ 371 Date: Sep. 25, 2025

(30) Foreign Application Priority Data
Mar. 31, 2023 (IT) 102023000006345

(51) Int. Cl. F01D 5/08; F01D 5/06; F01D 25/26; F01D 25/30; F02C 3/22; F02C 3/34

(52) U.S. Cl. CPC F01D 5/084; F01D 5/066; F01D 25/26; F01D 25/30; F02C 3/22; F02C 3/34; F05D 2230/23; F05D 2240/14; F05D 2260/213; F05D 2300/50212

(57) ABSTRACT

Disclosed herein is an expander for a high-pressure thermodynamic cycle, for instance a supercritical or transcritical carbon dioxide cycle. The expander comprises a rotor having a shaft and a plurality of rotor disks mounted on said shaft for co-rotation therewith. Each rotor disk comprises a respective annular row of rotor blades and is shrink-fitted on the shaft.

### TECHNICAL FIELD

The present disclosure concerns expanders particularly adapted for use in oxy-fuel combustion power cycles operating with process gas at high inlet pressures, for instance supercritical or transcritical CO₂ cycles, such as in Allam cycles, aka NET Power cycles.

### Background Art

Fossil fuels are a major source of chemical energy used for the generation of mechanical power. Fossil fuels are mixed with air and combusted to generate a combustion gas at high pressure and temperature, which expands in a turbine or a expander. The expander converts combustion gas enthalpy into mechanical power available on the output shaft of the expander and used to drive a load, such as a compressor or compressor train, or to rotate an electric generator and convert mechanical power into electric power.

One of the major concerns regarding combustion of fossil fuels relates to the production of carbon dioxide, a greenhouse gas which is considered one of the main contributors of global warming and climate changes.

To reduce the environmental impact of power generation through combustion of fossil fuels, the option of post combustion capture of carbon dioxide has been investigated. Carbon dioxide capture facilities have been developed, to process flue gas exhausted from gas turbines and remove carbon dioxide therefrom, prior to discharging the flue gas in the environment. The cost of a carbon dioxide capturing facility are high, both in term CAPEX, as well as in terms of energy required to run the facility, which reduces the overall thermodynamic efficiency of the system. The percentage of carbon dioxide in flue gas is low. This requires large volumes of flue gas to be processed through the carbon dioxide capturing facility and renders the capturing process particularly inefficient.

In recent years oxy-combustion cycles, also known as oxy-fuel cycles, have been developed, wherein fuel, such as natural gas or another fossil fuel, is blended into a mixture of an oxidant consisting mainly of oxygen (O₂) and carbon dioxide (CO₂) at high pressure. The blend of fuel, oxidant and carbon dioxide burns in a combustor of an expander producing a pressurized flue gas consisting exclusively or almost exclusively of carbon dioxide and water.

The flue gas is expanded in the expander to generate mechanical power. The exhaust flue gas discharged at the discharge side of the expander is cooled in a regenerative heat exchanger and further chilled to condensate water which can thus be removed from the chilled flue gas. The low-temperature flue gas, consisting mainly or exclusively of carbon dioxide is pressurized and recycled through the regenerative heat exchanger towards the combustor of the expander.

Oxygen supplied to the combustor of the expander can be obtained by separation from ambient air, removing nitrogen therefrom, such that the working fluid supplied to the combustor mainly consists of oxygen and carbon dioxide and does not include nitrogen. The resulting flue gas mainly consists of water and carbon dioxide. Water is removed from the flue gas by condensation and the part of water-free flue gas, which is not recycled to the combustor, can be efficiently processed in a carbon dioxide capturing unit.

The oxy-fuel cycle summarized above is a semi-closed cycle, in that only a fraction of the flue gas exits the cycle after water has been removed therefrom.

Oxy-fuel or oxy-combustion cycles, such as those described above are particularly interesting in terms of efficiency and reduction of noxious emissions. However, they operate under CO₂ supercritical or transcritical conditions and are characterized by high pressure drop across the expander and high torque applied to the rotor of the expander. These factors become critical and raise serious challenges in the expander rotor design, when the rated power of the expander increases and may pose limitations to the maximum power rate of the expander.

A novel rotor and turbomachine design adapted to achieve higher power rates, for instance in an oxy-fuel cycle, would be welcomed in the art.

### SUMMARY

Disclosed herein is an expander for a supercritical carbon dioxide thermodynamic cycle. The expander comprises an outer casing, a combustor in the outer casing or associated with or connected to the outer casing, and a rotor with a rotation axis, housed for rotation in the outer casing. The rotor comprises an intermediate haft portion on which a plurality of rotor disks is mounted by shrink-fitting. Each rotor disk comprises a respective annular row of rotor blades. Upstream of each annular row of rotor blades, a respective annular row of stationary vanes is provided. Each annular row of stationary vanes and the respective annular row of rotor blades form an expander stage.

Additional features and embodiments of the rotor and of a power-generating turbomachine including said rotor are described below with reference to the attached drawings and outlined in the attached claims.

### BRIEF DESCRIPTION OF THE DRAWINGS

Reference is now made briefly to the accompanying drawings, in which:

FIG. 1 is a schematic of an oxy-fuel power circuit;

FIG. 2 is a sectional view of an expander in one embodiment;

FIG. 3 is an enlarged sectional view, according to a plane parallel to the rotation axis, of a portion of the rotor;

FIG. 4 is a cross-sectional view according to line IV-IV of FIG. 3;

FIG. 5 is a cross-sectional view according to line V-V of FIG. 3;

FIG. 6 is a cross-sectional view according to line VI-VI of FIG. 3;

### DETAILED DESCRIPTION

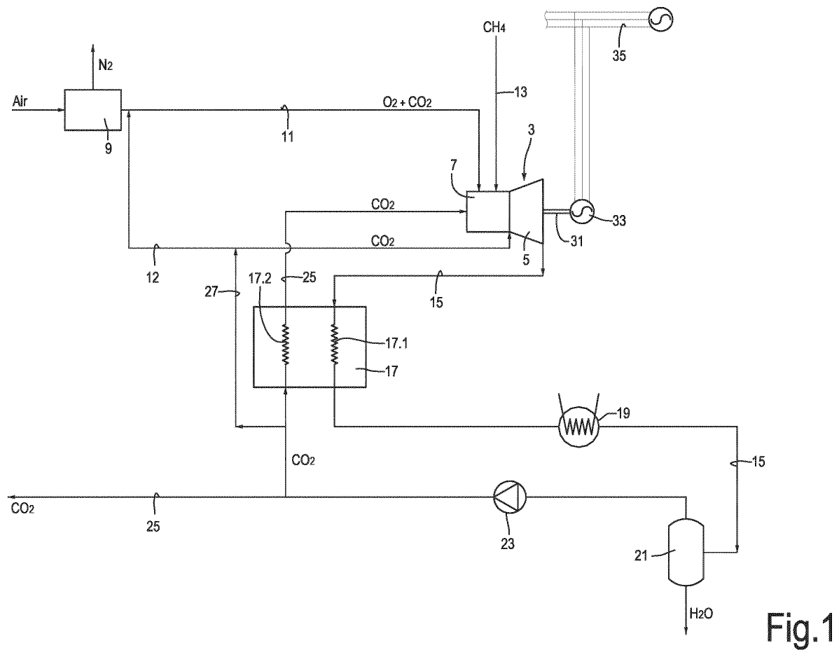

The schematic of FIG. 1 illustrates a simplified supercritical carbon dioxide cycle (shortly CO₂ cycle), such as an Allam cycle or as similar oxy-fuel combustion cycle, in which the use of an expander including a rotor according to the present disclosure can be particularly beneficial.

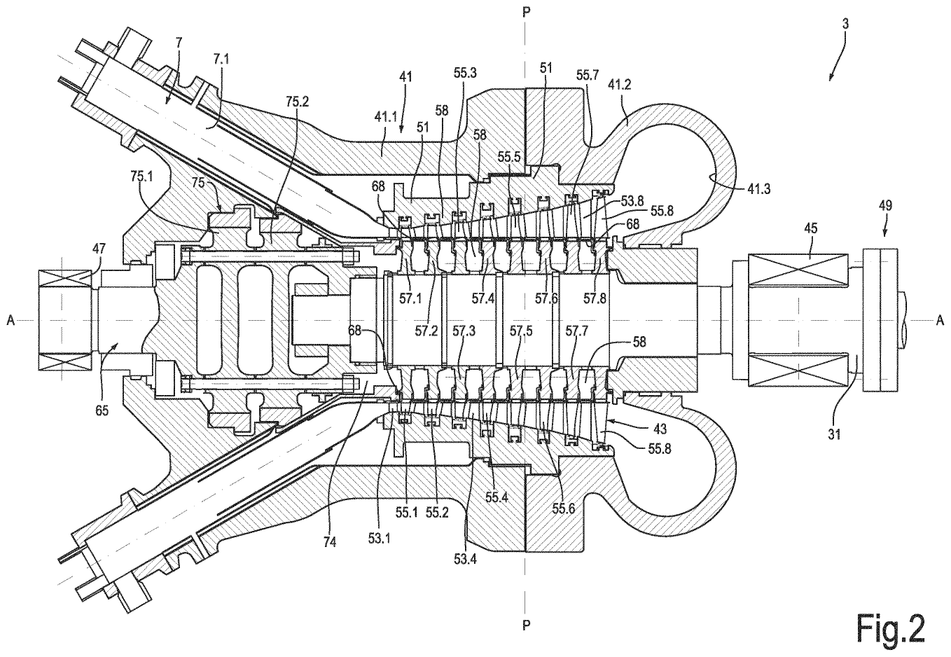

The power system 1 of FIG. 1 comprises an expander (aka turboexpander) 3 that includes an expansion section 5 and a combustor 7. The combustor 7 can be an annular combustor, a can-type combustor, a can-annular combustor, or the like, for instance. In currently preferred embodiments, the combustor is a can-type combustor comprising a plurality of combustion chambers arranged around the rotation axis of the expander 3, as shown in more detail in FIG. 2. The combustion chambers are housed in a respective seat formed in a high-pressure casing of the expander, as will be described in more detail below. Reference number 7.1 in FIG. 2 designates single combustion chambers of a can-type or can annular combustor. In other embodiments, not shown, the combustor can be an annular combustor, as mentioned.

The combustor 7 is supplied with an oxidant flow delivered by an oxidant source. The oxidant may be oxygen (O₂) or a blend of oxygen and carbon dioxide (CO₂). The oxidant flow can be produced by an air separation unit 9, which features an oxidant source. The air separation unit 9 may remove nitrogen or nitrogen and carbon dioxide from ambient air to produce the required oxidant stream which is supplied through an oxidant line 11 to the combustor 7 of the expander 3. In some embodiments, for the sake of easier handling of the oxidant flow, the latter may include around 20% by volume of oxygen and 80% by volume of carbon dioxide. The CO₂ and O₂ percentages mentioned above are by way of example. The carbon dioxide can be added to the oxygen through a recycling line 12.

Reference number 13 indicates a fuel supply line, for instance adapted to supply natural gas, such as methane, to the combustor 7, specifically to each combustion chamber 7.1 thereof. The oxidant and the fuel are supplied at the inlet side of the expander 3 to the combustor 7 at high pressure, for instance around or above 200 barA, preferably at around or above 250 barA, or higher, for instance at or above 300 barA. In general, the pressure can be below 600 barA. The oxidant-fuel blend is burned in the combustor 7. Pressurized, hot combustion gas resulting from the combustion expands in the expansion section 5 of the expander 3. The temperature at the exit side of the stationary nozzles downstream the combustor, i.e. at the inlet of the rotor of the expander 3 can be comprised between 800° C. and 1500° C., for instance.

The exhausted flue gas is discharged after expansion at a discharge side of the expander 3 in a discharge line 15. The flue gas in the discharge line 15 can be at a temperature between about 400° C. and about 700° C., for example around 600° C., and at a pressure which may range between about 10 barA and about 100 barA, preferably between about 20 barA and about 60 barA.

The circuit further comprises a regenerative heat exchanger 17, wherein hot flue gas flowing through a hot side 17.1 of the regenerative heat exchanger 17 is cooled in heat exchange with a flow of chilled flue gas which flows in a cold side 17.2 of the regenerative heat exchanger 17. The flue gas discharged from the hot side 17.1 of the regenerative heat exchanger 17 is further chilled in a chilling heat exchanger 19 to a temperature which causes condensation of steam contained in the exhausted flue gas. Condensing water is removed from the exhausted flue gas in a water/gas separator 21.

The de-hydrated exhausted and chilled flue gas, consisting mainly or exclusively of carbon dioxide, is compressed in a flue gas compressor 23 to the pressure at the inlet side of the expander 3. While in the schematic of FIG. 1 the flue gas compressor 23 is pictorially represented as a single compressor, in some embodiments multiple compressors can be used. For instance, the flue gas compressor 23 can be a multi-stage compressor or a compressor train. In some embodiments, a main compressor can be set in series with one or more sequentially arranged pumps

The compressed flue gas delivered by the flue gas compressor 23 is partly removed from the cycle through a discharge line 25. If the compressor 23 is featured by a plurality of turbomachines arranged in series, the discharge line 25 can be connected between two sequentially arranged turbomachines.

The major part of the compressed flue gas is delivered through the cold side 17.2 of the regenerative heat exchanger 17 and is heated by heat exchange with the hot flue gas flowing through the hot side 17.1 of the regenerative heat exchanger 17 and recycled to the expander 3 through a recycle line 25. The flue gas recycled through recycle line 25 is mixed with the combustion gas generated in the combustor 7, or with the oxidant stream from oxidant line 11.

A side stream of chilled flue gas is delivered through a cooling line 27, which bypasses the regenerative heat exchanger 17, towards components of the expander 3 which require cooling.

The expander 3 may include an output shaft 31, whereon mechanical power generated by the expansion of the combustion gas in the expansion section 5 of the expander 3 is available for mechanical drive or power generation purposes. In the exemplary embodiment of FIG. 1 the output shaft 31 is drivingly coupled to an electric generator 33, which is in turn electrically coupled to an electric power distribution grid 35. In FIGS. 1 and 2 the output shaft is shown at the aft side of the expander 3. In other embodiments, not shown, the output shaft 31 can be arranged at the forward side of the expander. In yet further embodiments, not shown, two output shafts can be provided, one at the forward side and one at the aft side of the expander.

As used herein “forward” and “aft” are referred to the direction of flow of the process gas through the expander 3. Therefore, “forward” indicates a position on the side of the combustor 7 and “aft” indicates a position on the side opposite the combustor 7, i.e., the discharge side of the expander 3.

The high pressure drop across the expander 3, the high absolute pressure in the combustor 7 and in the cooling ducts of the expanders, as well as the high torque applied to the expander shaft pose serious challenges in the design of the expander 3, in particular for high rated powers, for instance around or above 50 MW, preferably around or above 100 MW, more preferably around or above 150 MW, for instance around or above 200 MW. The power rate can be for instance equal to or lower than 2000 MW, preferably equal to or lower than 1500 MW, for instance equal to or lower than 1000 MW, or equal to or lower than 800 MW. In some embodiments the power rate can be comprised between 200 MW and 650 MW.

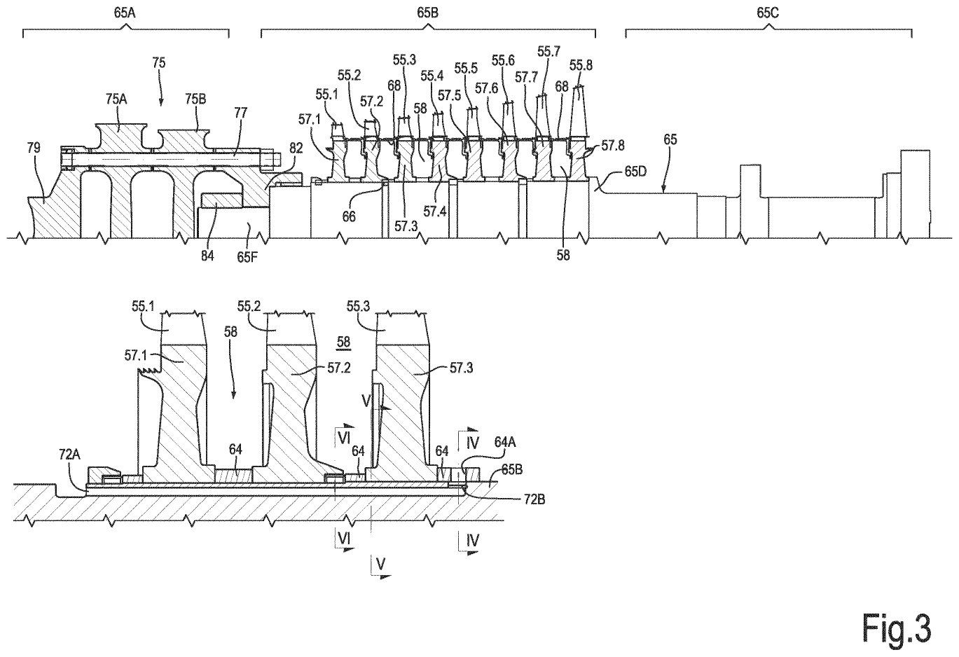

With continuing reference to FIG. 1, FIG. 2 illustrates a sectional view of the expander 3 in one embodiment and FIG. 3 an enlarged sectional view of a detail of the rotor of the expander.

The expander 3 comprises an outer casing 41, which houses the combustor 7. In some embodiments the outer casing 41 includes a main body 41.1, referred to herein as a high-pressure casing, and a closure 41.2, referred to herein as a low-pressure exhaust casing. The high-pressure casing 41.1 can include a main body, which can be monolithic, i.e., can consist of a single piece, for instance manufactured by forging, machining, casting, or combinations thereof. The high-pressure casing 41.1 can be in the shape of a barrel. The low-pressure exhaust casing 41.2 can be positioned on the discharge side, i.e. the aft side, of the expander 3, i.e., on the side opposite the combustor 7. The low-pressure exhaust casing 41.2 can be monolithic as well, i.e., can consist of a single piece for instance manufactured by forging, machining, casting, or combinations thereof.

The high-pressure casing 41.1 and the low-pressure exhaust casing 41.2 can be connected to one another along a plane P, which is orthogonal to a rotation axis AA of a rotor 43 supported for rotation in the outer casing 41.

In some embodiments, the low-pressure exhaust casing 41.2 forms a discharge volute, or a discharge plenum 41.3, through which exhausted flue gas is discharged from the expander 3. In some embodiments, the high-pressure casing 41.1 forms seats for individual combustion chambers 7.1, as shown in FIG. 2.

Reference numbers 45, 47 indicate bearing arrangements, which rotatingly support the rotor 43. For instance, the bearing arrangement 45 at the side opposite the combustor 7, i.e., at the aft side, may include an axial or thrust bearing in combination with a radial bearing, or a bearing having an axial-radial bearing capability. The bearing arrangement 47 on the combustor side, i.e., on the forward side, may include a radial bearing. A reversed arrangement is also possible, with a bearing having axial load capability arranged on the combustor side.

The rotor 43 can be drivingly coupled to the output shaft 31 thorough a joint 49. The bearing arrangements 45, 47 can be arranged in bearing casings, not shown in detail.

In some embodiments, the rotor 43 is surrounded by one or more inner casings 51, stationarily housed in the outer casing 41. Each inner casing 51 can be split into two portions along a plane parallel to the rotation axis A-A of the rotor 43, for instance a plane containing the rotation axis A-A. The arrangement of inner casings 51 and outer casing 41 is particularly beneficial when the combustion gas reaches high pressures, around 200-300 barA or higher. The monolithic high-pressure casing 41.1 can withstand the loads generated by the high pressure inside the outer casing, while the inner casings 51 facilitate mounting of the stationary vanes or stationary blades, described below, and forms a bundle with the rotor housed therein.

The pressure drop across the expander 3 can be around 200 bar or larger. To expand the combustion gas generated in the combustor 7 a high number of expansion stages is preferred. In the exemplary embodiment of FIG. 2 the expander 3 includes eight stages. In other embodiments, a different number of expansion stages can be foreseen, preferably equal to or higher than four, more preferably equal to or higher than five. In some embodiments, the number of expansion stages can be higher than eight, for instance nine, ten, eleven or more. The expansion stages form an axial flow path for the process gas being expanded through the expander 3.

Each expansion stage includes an annular row of stationary vanes or stationary blades 53 that are stationarily arranged in the expander casing. In the exemplary embodiment of FIG. 2, the annular rows of stationary blades are housed in the inner casings 51. Each expansion stage further includes a respective annular row of rotor blades 55. Each row of rotor blades 55 is arranged downstream a respective annular row of stationary blades along the process gas flow path, which extends from the combustor 7 through the expansion section 5 to the discharge plenum 41.3 in a forward-to-aft direction.

In some embodiments, a first annular row of stationary blades 53.1 can be arranged at the discharge end of the combustor 7 and form an array of nozzles directing hot, high-pressure combustion gas from the combustion chambers 7.1 of the combustor 7 to the first row of rotor blades. A first annular row of rotor blades labeled 55.1 can be arranged directly downstream of the first annular row of stationary blades 53.1 adjacent the combustor 7. A last annular row of stationary blades 53.8 can be positioned near the discharge plenum 41.3, upstream of the last annular row of rotor blades shown at 55.8. Reference number 55 generically refers to any one of the annular rows of rotor blades or to a rotor blade as such.

The rotor blades 55 form part of the rotor 43, i.e., are connected thereto for co-rotation with a rotor shaft 65. In embodiments, each annular row of rotor blades 55 (i.e. each row 55.i, with i=1 to 8) is connected to a respective rotor disk. The rotor disks are labeled 57.1, 57.2, 57.3, 57.4, 57.5, 57.6, 57.7 and 57.8. Reference number 57 indicates a generic rotor disk.

The rotor blades can be manufactured separately from the respective rotor disk and mounted thereon. In other embodiments, each rotor disk, or some of them, can be manufactured as a monolithic block with the respective rotor blades, for instance by additive manufacturing.

As best shown in FIG. 3, the rotor disks 57 are shrink-fitted on the shaft 65 of the rotor 43.

In embodiments, the shaft 65 comprises a forward shaft portion 65A, an intermediate shaft portion 65B and an aft shaft portion 65C. The rotor disks 57 are preferably shrink-fitted along the intermediate shaft portion 65B.

In some embodiments, the shaft 65 and the rotor disks 57 can be made of the same metal material. In other embodiments, e.g. to prevent loosening of the angular connection between the shaft 65 and the rotor disks 57 more efficiently, for instance during transients, due to temperature gradients, the shaft 65, and specifically the intermediate shaft portion 65B thereof is made of a material, having a first coefficient of thermal expansion, and the rotor disks 57 are made of a different material, having a second coefficient of thermal expansion, lower than the first coefficient of thermal expansion. In embodiments, the shaft 65, and specifically the intermediate shaft portion 65B, is made of a metal or metal alloy having a higher coefficient of thermal expansion than the material whereof the rotor disks 57 are made. The higher coefficient of thermal expansion of the inner portion of the rotor, consisting of the intermediate shaft portion 65B causes a larger thermal expansion of the shaft portion than the thermal expansion of the rotor disks, ensuring therewith stable connection between rotor disks on the one side and shaft o the other.

In embodiments, the rotor 43 can include a balance drum. The balance drum can be formed in the forward shaft portion or in the aft shaft portion.

As will be described in more detail here below, in the embodiment shown in the drawings, the balance drum is formed by the forward shaft portion 65A of the rotor shaft. In some embodiments, the forward shaft portion 65A and can be manufactured into two or more sections as shown in FIG. 2.

The intermediate shaft portion 65B and the aft shaft portion 65C are preferably manufactured as a single body, i.e., monolithically, as a single block.

To support the axial force generated by expansion of the process gas and applied to the rotor blades 55 and to the rotor disks 57, the intermediate shaft portion 65B can be provided with an annular abutment 65D. The annular abutment 65D can be positioned in the transition zone between the intermediate shaft portion 65B and the aft shaft portion 65C. At least the most downstream rotor disk 57.8 can abut against the annular abutment 65D and thereby transmit the axial thrust applied thereto to the rotor shaft.

All the remaining shrink-fitted rotor disks 57.1-57.7 can be pressed one against the other in axial direction by the force generated by the expansion of the process gas, such that the abutment 65D cooperates in supporting the full axial load applied on the rotor disks 57. Annular distancing rings 64 (see FIG. 3) can be arranged between adjacent rotor disks 57, to transfer the axial thrust applied to each rotor disk 57 to the next one in the forward-to-aft direction.

In some embodiments, intermediate abutment rings, also referred to as shear rings, labeled 66 can be mounted along the intermediate shaft portion 65B, as shown schematically in FIGS. 2, 3 and 6 between at least one pair of mutually adjacent rotor disks 57, or preferably between a plurality of pairs of adjacent rotor disks 57. In FIG. 2 a shear ring is positioned after each rotor disk 57 in an even position, i.e. after the 2nd, 4th and 6th rotor disks 57.2, 57.4 ad 57.6.

In some embodiments at least one or preferably each intermediate abutment ring or shear ring 66 can be manufactured in two or more ring sections or ring sectors. The ring sectors can be housed in a tangential slot 70, machined in the intermediate shaft portion 65B. In some embodiments, the tangential slot 70 can include a plurality of tangential slots, each extending for an angle smaller than 360° around the rotor axis. Each shear ring sector can be housed in a respective tangential slot.

For instance, FIG. 6 shows an enlarged cross sectional view of a portion of the rotor, where two tangential slots 70 are separated by a radial projection, wherethrough a cooling duct 72, to be described in more detail below, extends. Separate shear ring sectors 66 are housed in the separate tangential slots.

This ensures secure mechanical connection and ensures transfer of the axial thrust generated on respective rotor disks to the rotor shaft 65 during operation of the expander 3. More specifically, the shear rings provide a structural separation between axial thrust and torque transmission, for a more effective rotor design and improved mechanical resistance.

Between adjacent rotor disks 57 an annular space 58 closed by a seal runner 68 is usually provided, which is adapted to receive a cooling and/or purging fluid. In some embodiments, the rotor 43 comprises one or more cooling ducts extending preferably in an axial direction, i.e., parallel to the rotation axis A-A, or more generally in a longitudinal direction along the rotor 43.

Each cooling duct is adapted to feed cooling fluid to one or more annular spaces 58. In some embodiments, at least one independent cooling duct provides cooling fluid to only one annular space 58. In some embodiments, for particularly efficient cooling or purging of the annular spaces 58, a plurality of cooling ducts, for instance two, three or four cooling ducts are provided for each annular space 58, each cooling duct feeding a cooling medium to only one respective annular space 58.

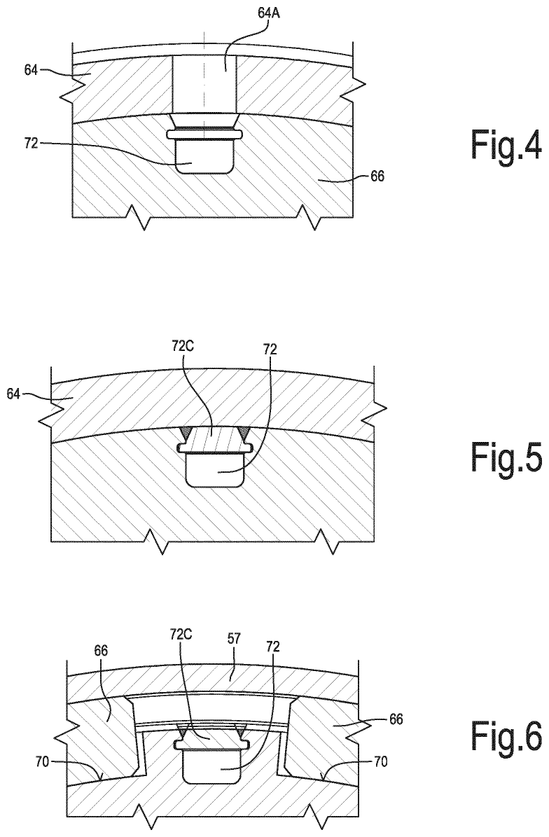

One cooling duct 72 is shown in the sectional views of FIGS. 3 to 6. Each cooling duct 72 has an inlet end 72A which is fluidly coupled with a cooling plenum 74 (FIG. 2) that can be provided in the forward area of the outer casing 41.

In embodiments, each cooling duct 72 can be formed by a slot extending longitudinally, and preferably parallel to the rotation axis, along the rotor shaft and specifically the intermediate shaft portion 65B. Each cooling duct 72 can be manufactured by milling and can be initially shaped as a channel open radially outwardly. A slab 72C can be welded along the slot such as to close the slot radially outwardly and form the cooling duct 72 having an inlet and an outlet at the opposite ends thereof

Cooling of the rotor 43 can be performed by feeding a pressurized cooling fluid to the cooling plenum 74 and therefrom to the cooling ducts 72 formed in the rotor 43. Specifically, in some embodiments, compressed and cooled carbon dioxide can be delivered to a cooling plenum 74.

The or each cooling duct 72 has at least one outlet aperture 72B fluidly coupled with one annular space 58, to deliver the cooling fluid therein. In some embodiments, the same cooling duct 72 can have a plurality of outlet apertures fluidly coupled to a plurality of annular spaces 58. In the embodiment shown in FIG. 3 the cooling duct 72 has a single outlet aperture 72B fluidly coupled to a single intermediate annular space 58. More than one cooling duct can be fluidly coupled to each annular space 58. In the embodiment of FIG. 3 the outlet aperture 72B is fluidly coupled to the annular space 58 through a port 64A formed in a respective distancing ring 64.

The cooling fluid delivered to annular spaces 58 between adjacent rotor disks 57 and under the respective seal runners 68 serves to purge the respective annular spaces 58 and prevent process gas from flowing therethrough, thus enhancing the efficiency of the expander 3. The pressure of the cooling fluid must therefore be sufficient to balance the pressure of the process gas which expands along the flow path formed by the stationary blades 53 and rotor blades 55. The pressure of the process gas decreases along the flow path from the first to the last expander stage. The pressure of the cooling fluid needed in the most upstream expander stages can be comprised between 200 barA and 600 barA, for instance. The axial thrust generated by the cooling fluid on the rotor disks 57 can be balanced by the shrink-fit coupling between the rotor disk and the shaft 65, and possibly by the annular abutment 65 and by the shear rings 66.

In some embodiments, the expander 3 comprises a balance drum drivingly coupled to the rotor 43. In the embodiment of FIG. 2, a balance drum 75 is provided at the forward end of the rotor 43, between the first expander stage and the forward bearing arrangement 47, and more specifically formed by the forward shaft portion 65A.

In some embodiments the balance drum 75 is integrally formed with the forward shaft portion 65A.

In the embodiment of FIG. 2 the balance drum 75 comprises two balance drum portions 75A and 75B, which are coupled to one another by a set of tie rods 77 arranged round the rotation axis A-A. The tie rods 77 connect the balance drum portions 75A, 75B to one another and to a forward end section 79 of the forward shaft portion 65A, the forward end section 79 extending through the forward bearing arrangement 47.

Additionally, the tie rods 77 connect the balance drum 75 and the forward end section 79 of the rotor shaft 65 to the intermediate shaft portion 65B.

In some embodiments, the forward shaft portion comprises an inner flange 82 which can be coupled to a coaxial shank 65F of the intermediate portion 65B of the shaft 65. The balance drum 75 is coupled to the flange 82 by the tie rods 77. The flange 82 can be coupled to the shank 65F by means of a nut 84 screwed on a threaded portion of the shank 65F.

By splitting the forward shaft portion 65A into several components, specifically the balance drum portions 75.1, 75.2, the forward shaft end 79 and the flange 82, manufacturing of the balance drum and of the forwards shaft portion 65A, for instance by forging, is facilitated.

Exemplary embodiments have been disclosed above and illustrated in the accompanying drawings. It will be understood by those skilled in the art that various changes, omissions, and additions may be made to that which is specifically disclosed herein without departing from the scope of the invention as defined in the following claims.

For instance, while in the embodiment disclosed herein the combustor is housed in the expander, in other embodiments, the combustor can be arranged outside the expander.

In yet further embodiments, the expander disclosed herein can be use in close-loop thermodynamic cycle, such as a supercritical carbon dioxide cycle, where heat is introduced in the thermodynamic cycle through a heat exchanger, rather than using a combustor.

1. An expander for a supercritical or transcritical carbon dioxide thermodynamic cycle, the expander comprising:
an outer casing;
at least one combustor combined with the outer casing, the at least one combustor being adapted to receive a flow of compressed oxidant and a fuel;
a rotor with a rotation axis, housed for rotation in the outer casing; wherein the rotor comprises:
a shaft;
a plurality of rotor disks mounted on the intermediate shaft portion; wherein each rotor disk of said plurality of rotor disks comprises a respective annular row of rotor blades; and
upstream of each annular row of rotor blades, a respective annular row of stationary vanes;
wherein each annular row of stationary vanes and the respective annular row of rotor blades form an expander stage;
at least one cooling duct extending along the shaft, the cooling duct having an inlet end adapted to be fluidly coupled to a high-pressure plenum of the turbomachine when the rotor is mounted in the turbomachine, and fluidly coupled to at least one intermediate annular space between a pair of sequentially arranged rotor disks;
wherein each rotor disk of said plurality of rotor disks is mounted on the shaft by shrink-fitting.

2. The expander of claim 1, wherein the shaft is made at least partly made of a first metal alloy and the rotor disks are made of a second metal alloy, and wherein the first metal alloy has a coefficient of thermal expansion higher than a coefficient of thermal expansion of the second metal alloy.

3. The expander of claim 1, wherein the shaft comprises a forward shaft portion, an intermediate shaft portion and an aft shaft portion; wherein the rotor disks are shrink-fitted on the intermediate portion of the shaft; wherein the intermediate shaft portion and the aft shaft portion are formed integrally as a monolithic body; wherein the shaft comprises an abutment formed monolithically with the shaft, between the intermediate portion and the aft portion; and wherein at least a most downstream of said rotor disks abuts against said abutment

4. The expander of claim 3, further comprising at least one annular abutment fitted on the intermediate shaft portion of the shaft and arranged between two consecutive rotor disks.

5. The expander of claim 1, further comprising a balance drum.

6. The expander of claim 1, wherein the forward shaft portion features a balance drum.

7. The expander of claim 1, wherein the balance drum comprises a first balance drum portion and a second balance drum portion connected to one another through at least one tie rod and preferably through a plurality of tie rods arranged peripherally around a rotation axis of the rotor at a radial distance therefrom.

8. The expander of claim 1, wherein the forward shaft portion comprises an inner flange, coupled to a coaxial shank of the intermediate portion, and wherein the balance drum is coupled to said flange by said tie rods.

9. The expander of claim 1, further comprising distancing rings between pairs of adjacent rotor disks.

10. The expander of claim 1, further comprising at least one shear ring interposed between two consecutive rotor disks.

11. The expander of claim 1, further comprising a plurality of cooling ducts for a plurality of rotor stages; wherein each cooling duct extends along the shaft and has an inlet end adapted to be fluidly coupled to a high-pressure plenum of the turbomachine when the rotor is mounted in the turbomachine, and fluidly coupled to a respective intermediate annular space between a pair of sequentially arranged rotor disks.

12. The expander of claim 1, wherein each cooling duct is configured as a slot extending in a longitudinal direction along the rotor and inside an outer surface of the rotor; wherein said slot is closed by a slab having an inner surface facing the slot and an outer surface flush with the outer surface of the rotor.

13. The expander of claim 1, wherein each cooling duct is fluidly coupled to a respective annular space through a port provided in a distancing ring, the distancing ring being positioned between the pair of sequentially arranged rotor disks, between which the annular space is formed.

14. The expander of claim 1, further comprising at least one shear ring comprising a plurality of ring sectors, each ring sector being housed in a respective tangential slot of the rotor; and wherein the at least one cooling duct extends between two adjacent ring sectors and respective tangential slots in which the ring sectors are housed.

15. The expander of claim 1, comprising a plurality of shear rings for a plurality of rotor disks, up to at least one shear ring for each rotor disk.

16. The expander of claim 1, further comprising a high-pressure plenum adapted to receive a compressed coolant fluid, fluidly coupled with at least one cooling duct extending along the shaft, the cooling duct being fluidly coupled to the high-pressure plenum and to at least one intermediate annular space between a pair of sequentially arranged rotor disks.

17. The expander of claim 1, wherein the outer casing comprises a high-pressure casing and a low-pressure exhaust casing; wherein the high-pressure casing and the low-pressure exhaust casing are coupled along a plane orthogonal to the rotation axis.

18. The expander of claim 17, wherein the high-pressure casing comprises a monolithic barrel body or the low-pressure exhaust casing is configured as a monolithic body.

19. The expander of claim 17, wherein the low-pressure exhaust casing is configured as a monolithic body.

20. The expander of claim 1, wherein the outer casing comprises at least one seat, and wherein the at least one combustor is at least partly housed in said seat.

21. (canceled)

22. The expander of claim 1, further comprising at least one inner casing, and preferably a plurality of inner casings, stationarily housed in the outer casing, and surrounding the rotor; wherein each inner casing is split into a first casing portion and a second casing portion along a plane parallel to the rotation axis of the rotor;
and wherein the inner casing contains annular rows of stationary blades.

23-25. (canceled)

26. A supercritical or transcritical carbon dioxide thermodynamic circuit comprising:
an oxidant source;
an expander with an inlet side and a discharge side, wherein the inlet side is fluidly coupled to the oxidant source;
a flue gas recycling line, adapted to recycle flue gas from the discharge side of the expander to a combustor of the expander;
in the flue gas recycling line, a cooler adapted to cool the flue gas from the discharge side of the expander and condense water contained in the flue gas;
a regenerative heat exchanger, wherein flue gas from the expander flows in heat exchange with chilled flue gas from the cooler; wherein the expander is an expander according to claim 1.
